(19) United States
(12) Patent Application Publication
(10) Pub. No.: US 2011/0034606 A1
(43) Pub. Date: Feb. 10, 2011

(54) COMPOSITE DIELECTRIC COMPOSITION HAVING SMALL VARIATION OF CAPACITANCE WITH TEMPERATURE AND SIGNAL-MATCHING EMBEDDED CAPACITOR PREPARED USING THE SAME

(75) Inventors: Eun Tae PARK, Yongin (KR); Yul Kyo Chung, Yongin (KR); Seung Hyun Sohn, Suwon (KR); Min Ji Ko, Suwon (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD., Kyungki-do (KR)

(21) Appl. No.: 12/906,540

(22) Filed: Oct. 18, 2010

Related U.S. Application Data
(62) Division of application No. 11/580,118, filed on Oct. 13, 2006.

(30) Foreign Application Priority Data
Oct. 13, 2005 (KR) 10-2005-0096661

(51) Int. Cl. C08K 3/22

(52) U.S. Cl. 524/403; 524/431; 524/413

(57) ABSTRACT

Disclosed herein is a composite dielectric composition having a small variation of capacitance with temperature, comprising a combination of a polymer matrix exhibiting a positive or negative variation of capacitance with temperature and a ceramic filler exhibiting a negative or positive variation of capacitance with temperature which is reciprocal to that of the polymer matrix; and a signal-matching embedded capacitor prepared by using the same composition. Particularly, the present invention provides a composite dielectric composition comprising a polymer matrix exhibiting a positive or negative variation of capacitance with temperature and a ceramic filler exhibiting a variation of capacitance which is reciprocal to that of the polymer matrix; and a signal-matching embedded capacitor formed of the same composition and having a variation of capacitance with temperature, ΔC/C×100(%), of not more than 5%. The composite dielectric composition of the present invention can be used in preparation of the signal-matching embedded capacitor due to a small variation of capacitance with temperature.

### RELATED APPLICATIONS

The present application is based on, and claims priority from, Korean Application Number 2005-0096661, filed Oct. 13, 2005, the disclosure of which is incorporated by reference herein in its entirety.

### BACKGROUND OF THE INVENTION

1. Field of the Invention

The present invention relates to a composite dielectric composition having a small variation of capacitance with temperature, comprising a polymer matrix and a ceramic filler, and a signal-matching embedded capacitor comprising a dielectric layer made of the same composition. More specifically, the present invention relates to a composite dielectric composition having a small variation of capacitance with temperature, comprising a combination of a polymer matrix exhibiting a positive or negative variation of capacitance with temperature and a ceramic filler exhibiting a negative or positive variation of capacitance with temperature which is reciprocal to that of the polymer matrix; and a signal-matching embedded capacitor comprising a dielectric layer made of the same composition.

2. Description of the Related Art

Recently, due to an ongoing trend toward the miniaturization and higher frequency applications of multilayer circuit boards, passive devices, which have been conventionally mounted and arranged on printed circuit boards (PCBs), serve as an obstacle against miniaturization of such circuit board products. In particular, speeding trends toward the development of embedded systems and increasing numbers of input/output terminals in semiconductor devices result in difficulties to secure the arrangement space for numerous passive devices including capacitors disposed around active chips. As an attempt to overcome limitations associated with optimal disposition of the capacitors around the active devices, so as to keep up with the trends toward miniaturization and higher frequency applications of semiconductor devices, there have been proposed methods of embedding such passive devices including the capacitor immediately below active chips of the circuit boards or methods of reducing an inductance value of the chips. As such, multi-layer ceramic capacitors (MLCCs) having low equivalent series inductance (Low ESL) have been actively developed.

As an alternative solution to overcome the above-mentioned problems associated with optimal disposition of passive devices, embedded capacitors have been suggested. The embedded capacitor is a capacitor which is fabricated by forming one layer below the active chip of PCBs into a dielectric layer. U.S. Pat. Nos. 5,079,069, 5,162,977, 5,155,655 assigned to Sanmina Corporation (USA) and U.S. Pat. No. 5,161,086 assigned to Zycon Corporation (USA) disclose methods of minimizing high frequency-induced inductance by minimizing the length of the lead wire connected to the capacitor via disposition of the embedded capacitor in the closest proximity of the input terminal of the active chip. It is known that desired characteristics can also be achieved by using, as a dielectric material for capacitors used to realize such an embedded capacitor, a glass fiber-reinforced epoxy resin, known as FR4, which has been conventionally used as one of PCB members. It is also known that the desired capacitance may be achieved by using a composite material formed by dispersing in an epoxy resin a barium titanate (BaTiO₃) filler, a high-dielectric constant ferroelectric material.

Meanwhile, the capacitors make up about 35 to 45% of the total area of passive devices practically mounted on the circuit boards and the majority of capacitors are intended for decoupling or signal matching. As materials for conventional embedded capacitors, there have been used materials which were formed by dispersion of a ferroelectric powder having a high-dielectric constant in an epoxy resin. The capacitors manufactured using such capacitor materials are primarily used as decoupling capacitors having a dielectric constant of more than 20. As such, fabrication of the decoupling capacitors has been largely directed toward utilization of ferroelectric powders and epoxy resins.

There are known conventional arts relating to capacitor dielectric compositions. For example, Korean Patent Laid-open Publication No. 2004-30801 discloses a method of enhancing adhesion between the dielectric layer and the copper substrate during a high-temperature lamination process. Korean Patent Laid-open Publication No. 2003-24793 discloses a high-dielectric constant material formed of superfine ceramic particles dispersed in a polymer matrix wherein the dielectric layer uses polymeric matrices such as epoxy resins and polyimide resins and ceramic fillers such as barium titanate, strontium titanate and lead zirconium titanate. However, none of these patents disclose a method for minimizing variation of capacitance with temperature, which is the technical subject matter that will be addressed by the present invention.

Further, there is yet little known about the development of dielectric compositions for signal-matching capacitors, unlike as shown in decoupling capacitors. This is because ferroelectric powder-dispersed epoxy resins cannot meet the temperature characteristics of capacitance which are required by signal-matching capacitors. Generally, the ferroelectric powders undergo phase transition from a tetragonal phase to a cubic phase at Curie temperature (Tc), during which the dielectric constant drastically increases by stress. An increase of the dielectric constant directly leads to an increase of the capacitance, and elevation of the temperature results in significant fluctuation of the capacitance.

When variation of capacitance with temperature satisfies the X7R characteristics, the dielectric material of interest may be used as the material for the decoupling capacitor. However, in order to ensure that such a dielectric material can be used as the signal-matching capacitor, the material should have a lower deviation of the capacitance variation within the same temperature range. That is, the dielectric material for the signal-matching capacitor must be a material which exhibits extremely low variation of capacitance with temperature. For example, U.S. Pat. No. 6,608,760 discloses a material in which temperature stability of an epoxy/BaTiO₃ composite system meets requirements of X7R by controlling the phase of ferroelectric powder. However, the capacitor material disclosed in this art suffers from significant fluctuation of the capacitance and therefore cannot be applied to signal-matching embedded capacitors.

On the other hand, currently available embedded capacitors generally employ a ferroelectric ceramic filler and an epoxy resin as main materials. However, use of the ferroelectric ceramic filler, due to occurrence of phase transition phenomenon, leads to a sharp increase in the capacitance at around Curie temperature (Tc). Further, owing to inherent polarity of a material, the use of the epoxy resin is accompanied by dipole polarization, which consequently, in conjunction with increasing temperatures, contributes to an increase of a capacitance value.

As an attempt to reduce variation of capacitance with temperature in the conventional composite dielectric composition, the method of decreasing a capacitance value with temperature of individual polymer matrix and ceramic filler which constitute a composite system was commonly used. However, due to a low dielectric constant intrinsic to the materials, polymer resins having small variation of capacitance with temperature, such as benzocyclobutene (BCB) and liquid crystalline polymers (LCPs), fail to meet capacitance characteristics required by the capacitors.

Therefore, when it is desired to use low-dielectric constant polymer materials such as BCB and LCPs, ceramic fillers having a high-dielectric constant should be used to increase the capacitance. However, the high-dielectric constant ferroelectric fillers, as discussed hereinbefore, undergo significant variation of the capacitance with varying temperatures. Hence, upon using the composite dielectric composition composed of the polymer resin including BCB and LCPs and the ferroelectric filler, the sum of temperature characteristics of each component is reflected as an increasing variation of capacitance with varying temperatures of the composite system. Further, use of BCB or LCPs suffers from poor processability, as compared to conventional epoxy resins.

### SUMMARY OF THE INVENTION

Therefore, the present invention has been made in view of the above problems, and it is an object of the present invention to provide a composite dielectric composition having a small variation of capacitance with temperature.

It is another object of the present invention to provide a composite dielectric composition having a variation of capacitance with temperature, ΔC/C×100(%), of not more than 5%.

It is a further object of the present invention to provide a composite dielectric composition which has a small variation of capacitance with temperature and is therefore used in a signal-matching embedded capacitor.

It is yet another object of the present invention to provide a signal-matching embedded capacitor having a variation of capacitance with temperature, ΔC/C×100(%), of not more than 5%.

In accordance with an aspect of the present invention, the above and other objects can be accomplished by the provision of a composite dielectric composition comprising a polymer matrix exhibiting a positive or negative variation of capacitance with temperature and a ceramic filler exhibiting a negative or positive variation of capacitance with temperature which is reciprocal to that of the polymer matrix.

In accordance with another aspect of the present invention, there is provided a signal-matching embedded capacitor including a dielectric layer formed of the above-mentioned composite dielectric composition and having a variation of capacitance with temperature, ΔC/C×100(%), of not more than 5%.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph showing capacitance variations of mixtures, upon mixing of materials exhibiting different variation behavior of capacitance with temperature;

FIG. 2A is a graph showing a capacitance variation value of an epoxy resin exhibiting a positive variation of capacitance with temperature; and

FIG. 2B is a table showing a capacitance variation value of an epoxy resin of FIG. 2A.

### DESCRIPTION OF THE PREFERRED EMBODIMENTS

Hereinafter, the present invention will be described in more detail.

A composite dielectric composition of the present invention exhibits stable capacitance with little variation, due to a low temperature coefficient of capacitance (TCC). That is, the composition of the present invention shows a low variation of capacitance with temperature, i.e., ΔC/C×100(%) of not more than 5%. The composition of the present invention is therefore suitable as a dielectric material for signal-matching embedded capacitors.

The composite dielectric composition (hereinafter, sometimes referred to as “dielectric composition”) of the present invention having a small variation of capacitance with temperature (hereinafter, sometimes referred to as “temperature characteristics”) was developed based on the fact that temperature characteristics are reflected as the sum of temperature characteristics of each component constituting the dielectric composition.

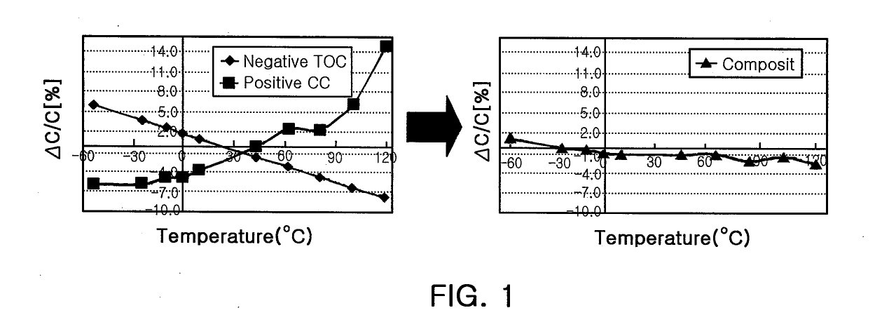

In order to reduce a variation of capacitance with temperature, the dielectric composition of the present invention is prepared by using a mixture of materials having different temperature characteristic behavior. Such a concept of the present invention is schematically shown in FIG. 1.

As shown in FIG. 1, use of a composite of a material exhibiting a positive variation of capacitance with an increasing temperature, in admixture with a material exhibiting a negative variation of capacitance with an increasing temperature results in the compensation of temperature characteristics between different materials, thereby decreasing TCC. Consequently, the stable capacitance is achieved with little deviation in variation of capacitance.

As shown in FIG. 1, the material exhibiting positive temperature characteristics, in admixture with the material exhibiting negative temperature characteristics, leads to decreases of a change rate in the temperature characteristics of the dielectric composition. When the dielectric composition is prepared in this manner, the selection of the dielectric materials, i.e., polymer resins and ceramic fillers, is not limited to within materials having a small variation of capacitance with temperature, very near to zero. Consequently, it is possible to design various dielectric compositions due to broad selectability of the dielectric materials. Therefore, common epoxy resins can be used as a polymer matrix, instead of using expensive BCB or LCPs. In addition, it is possible to control the capacitance and the variation of capacitance with temperature to within various ranges as desired, by varying the amounts and compositions of the selected polymer matrix and ceramic filler.

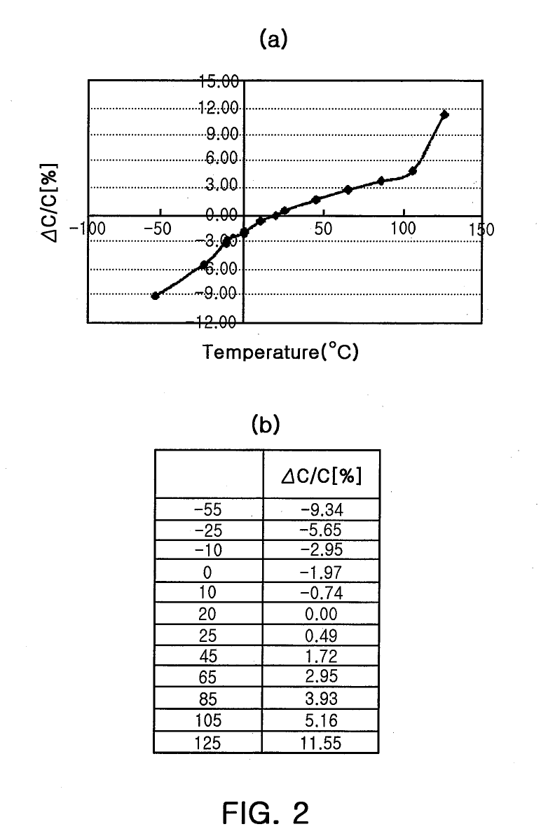

As such an example, FIG. 2A graphically shows a variation of capacitance with temperature for the epoxy resin. FIG. 2B is a table showing a variation of capacitance with temperature in the terms of numerical values corresponding to the graphical values of FIG. 2A. As can be seen from FIGS. 2A and 2B, the epoxy resin has positive temperature characteristics in that the capacitance value also increases as the temperature increases. As a result, by preparing the dielectric composition using the epoxy resin in admixture with the ceramic filler having temperature characteristics opposite to those of the epoxy resin, i.e., negative temperature characteristics accompanied by a decrease of the capacitance value in response to elevation of the temperature, it is possible to decrease a variation of capacitance with temperature.

As examples of the polymer matrix exhibiting positive temperature characteristics, mention may be made of epoxy resins, polyethylene terephthalate resins and polyimide resins. These resin materials may be used alone or in any combination thereof.

There is no particular limitation to the epoxy resins that can be used in the present invention, and those disclosed in Korean Patent Application No. 2005-12483 may be used. Specific examples of the epoxy resins disclosed in this art include a resin composition comprised of 10 to 40 wt % of a brominated epoxy resin containing 40 wt % or more bromine, and 60 to 90 wt % of at least one resin selected from the group consisting of bisphenol-A novolac epoxy resins, multi-functional epoxy resins, polyimides, cyanate esters and any combination thereof; and a resin composition comprised of 1 to 50 wt % of at least one resin selected from the group consisting of bisphenol-A epoxy resins, bisphenol-F epoxy resins and any combination thereof, 9 to 60 wt % of a brominated epoxy resin containing 40 wt % or more bromine, and 30 to 90 wt % of at least one resin selected from the group consisting of bisphenol-A novolac epoxy resins, multi-functional epoxy resins, polyimides, cyanate esters and any combination thereof.

When the polymer matrix exhibiting positive temperature characteristics is used, the dielectric composition may be prepared using the ceramic filler having MO6 group(s) or a Perovskite structure and exhibiting negative temperature characteristics, in order to increase the dielectric constant while minimizing variation of the capacitance with temperature.

Examples of the ceramic filler exhibiting negative temperature characteristics may include calcium titanate (CaTiO₃), strontium titanate (SrTiO₃), zinc titanate (ZnO—TiO₂) and bismuth titanate (Bi₂O₃-2TiO₂). These ceramic materials may be used alone or in any combination thereof. Particularly, it is preferred to use the dielectric composition in which calcium titanate (CaTiO₃) or strontium titanate (SrTiO₃) is dispersed in the epoxy resin.

Temperature characteristics of the fillers exhibiting negative temperature characteristics are given in Table 1 below.

TABLE 1

| | Dielectric | Q | Tc min |
|---|---|---|---|
| Materials | constant | (1 MHz) | (×10⁻⁶/° C.) |
| TiO₂ | 90-110 | >5000 | N750 |
| CaTiO₃ | 150-160 | >3000 | N1500 |
| SrTiO₃ | 240-260 | >1500 | N3300 |
| ZnO—TiO₂ | 35-38 | >1500 | N60 |
| Bi₂O₃—2TiO₂ | 104-110 | >1000 | N1500 |

*N represents negative temperature characteristics

Alternatively, it is also possible to prepare a dielectric composition exhibiting little variation of temperature characteristics by the combination of a polymer matrix exhibiting negative temperature characteristics with a ceramic filler exhibiting positive temperature characteristics. Examples of the polymer matrix exhibiting negative temperature characteristics include Teflon resin (TCC: −100 ppm/° C.), bismaleimide-methylenedianiline (BMI-MDA) polyimide resins and the like, which may be used alone or in any combination thereof. Examples of the ceramic filler exhibiting positive temperature characteristics may include barium titanate (BaTiO₃), lanthanum titanate (La₂O₃—TiO₃, TCC: +600 ppm/° C.), magnesium titanate (MgTiO₃, TCC: +100 ppm/° C.) and the like. These ceramic materials may also be used alone or in any combination thereof. Preferably, composite dielectric composition may be prepared by using a combination of the Teflon resin with barium titanate (BaTiO₃), or a combination of the BMI-MDA polyimide resin with lanthanum titanate (La₂O₃—TiO₃) or magnesium titanate (MgTiO₃).

In order to reduce a temperature coefficient of capacitance (TCC), the present invention uses the dielectric composition composed of the ceramic filler and polymer matrix. However, if there is no need to control the capacitance variation of the polymer matrix forming a dielectric, it is preferred to form the dielectric layer only with the polymer matrix (resin), upon taking adhesive strength into consideration. The polymer matrix and ceramic filler in the dielectric composition of the present invention are mixed in a ratio to meet desired temperature characteristics, i.e., variation of capacitance with temperature, ΔC/C×100(%), of not more than 7%, preferably 5%. Specifically, based on the total volume of the polymer matrix and ceramic filler in the dielectric composition, it is desirable to mix less than 60 vol %, preferably less than 50 vol % of the ceramic filler with the polymer matrix. If the content of the ceramic filler in the dielectric composition exceeds 60 vol %, this may undesirably lead to poor adhesion with copper (Cu) foil which is used as top and bottom electrodes upon fabrication of the capacitor, consequently causing the problems associated with reliability.

The dielectric composition is prepared by dispersing the ceramic filler into the polymer matrix in the presence of a suitable solvent. Preferably, the ceramic filler has a particle diameter of 10 nm to 10 μm. If the particle diameter of the filler is less than 10 nm, dispersion of the ceramic filler into the polymer matrix is poor. If the particle diameter of the filler is greater than 10 μm, the thickness of the dielectric composite may be undesirably increased, thereby resulting in decreased capacitance.

The dielectric composite of the present invention may further include additives such as a curing agent, a curing accelerator, a defoaming agent and a dispersing agent, if necessary. Kinds and contents of the additives may vary depending upon kinds of the used polymer matrices and ceramic fillers, which are conventionally used in the art and may be appropriately chosen by those skilled in the art, if necessary.

For example, when the epoxy resin is used, conventionally known curing agents for epoxy resins may be used. Examples of the epoxy resin curing agents include, but are not limited to, phenols such as phenol novolac, amines such as dicyanoguanidine, dicyandiamide, diaminodiphenylmethane and diaminodiphenylsulfone, acid anhydrides such as pyromellitic anhydride, trimellitic anhydride and benzophenone tetracarboxylic anhydride, and any combination thereof.

Examples of the epoxy resin curing accelerators that can be used in the present invention may include bisphenol-A novolac resin and the like.

The embedded capacitors whose dielectric layer is formed of the dielectric composition of the present invention have a variation of capacitance with temperature, ΔC/C×100(%), of not more than 5%, and may be used as a signal-matching embedded capacitor.

### EXAMPLES

Now, the present invention will be described in more detail with reference to the following examples. These examples are provided only for illustrating the present invention and should not be construed as limiting the scope and spirit of the present invention.

### Examples 1 Through 6 and Comparative Examples 1 and 2

Composite dielectric compositions were respectively prepared by mixing a ceramic filler and an epoxy resin in a predetermined ratio as set forth in Table 2 below. As the epoxy resin composition, these Examples and Comparative Examples employed a mixture of a bisphenol-A epoxy resin/brominated bisphenol-A epoxy resin/bisphenol-A novolac epoxy resin in a weight ratio of 2:2:6, disclosed in Example 2 of Korean Patent Application No. 2005-12483. Further, these Examples and Comparative Examples employed a bisphenol-A novolac resin as a curing agent, 2-methylimidazole as a curing accelerator, and 2-methoxyethanol as a solvent, respectively.

110 g of a slurry batch composed of the ceramic filler and epoxy resin mixed in a ratio of vol % as set forth in Table 2 below, curing agent, curing accelerator and dispersing agent was used to prepare a slurry to which a solvent was added in an amount of 10 wt % relative to the batch. Herein, the curing agent and curing accelerator were respectively added in an amount of 52.769 wt % and 0.1 wt %, relative to the epoxy resin. In addition, the dispersing agent was added in an amount of 3 wt %, relative to the ceramic powder. These materials were mixed for 12 hours using a ball mill, thereby preparing a dielectric slurry. As the ceramic filler, a filler having a particle diameter of about 0.1 to 1 μm was used. The thus-prepared slurry was cast in a thickness of 100 μm over copper foil, by means of hand casting. Thereafter, the dielectric-cast coil foil was semi-cured in a drying oven at 170° C. for 2.5 min, and then compressed at 300 psi for 10 min using WIP.

The thus-compressed samples were laminated at 200° C. for 2 hours to prepare a copper-clad laminate (CCL) which was then etched with the exception of an electrode part, using an aqueous nitric acid solution, thereby preparing samples for measuring dielectric constants and temperature characteristics. Dielectric properties (dielectric constant and dielectric loss) of the thus-prepared samples were measured at 1 kHz using HP4294A impedance analyzer. Further, using Single Chamber Capacitor Temp Test System (W-2500), variations of capacitance with temperature (temperature characteristics) were measured in terms of ΔC/C×100(%) (C: Capacitance at 25° C., and ΔC: Variation of capacitance with temperature). Dielectric properties and temperature characteristics thus measured are given in Tables 2 and 3, respectively.

TABLE 2

| | | Amount | Amount of | Dielectric | Dielectric |
|---|---|---|---|---|---|
| Example | | of filler | epoxy resin | Constant | Loss |
| No. | Filler | (vol %) | (vol %) | (at 1 kHz) | (at 1 kHz) |
| Comp. | BaTiO₃ | 45 | 55 | 23 | 0.02 |
| Ex. 1 | | | | | |
| Comp. | TiO₂ | 45 | 55 | 57.4 | 0.5 |
| Ex. 2 | | | | | |
| Ex. 1 | SrTiO₃ | 35 | 65 | 16.1 | 0.008 |
| Ex. 2 | SrTiO₃ | 45 | 55 | 21.5 | 0.004 |
| Ex. 3 | CaTiO₃ | 35 | 65 | 14.9 | 0.007 |
| Ex. 4 | CaTiO₃ | 40 | 60 | 17.4 | 0.004 |
| Ex. 5 | CaTiO₃ | 45 | 55 | 20.6 | 0.003 |
| Ex. 6 | CaTiO₃ | 50 | 50 | 23.8 | 0.003 |

TABLE 3

| Temp. | Comp. | Comp. | | | | | | |
|---|---|---|---|---|---|---|---|---|
| (° C.) | Ex. 1 | Ex. 2 | Ex. 1 | Ex. 2 | Ex. 3 | Ex. 4 | Ex. 5 | Ex. 6 |
| −55.00 | −11.57 | −47.30 | −3.47 | −2.81 | −2.46 | −4.01 | −2.43 | −0.76 |
| −24.95 | −7.19 | −34.46 | 2.56 | −1.08 | −0.20 | 0.25 | −0.27 | −1.20 |
| −9.99 | −4.15 | −25.68 | −2.37 | −0.43 | 1.18 | −0.29 | 0.31 | 0.60 |
| 0.03 | −2.59 | −18.24 | −1.88 | 0.43 | 0.29 | −0.05 | 0.35 | 0.54 |
| 10.04 | −1.37 | −9.46 | −1.21 | 0.65 | 0.20 | 0.08 | 0.25 | 0.36 |
| 20.03 | −0.44 | 2.70 | −1.08 | 1.08 | 0.10 | 0.13 | 0.10 | 0.12 |
| 25.00 | −0.04 | 9.46 | −0.37 | 0.87 | 0.00 | 0.76 | 0.00 | 0.00 |
| 45.06 | 1.67 | 43.24 | −1.99 | 2.16 | −0.29 | 0.01 | −0.33 | −0.48 |
| 65.03 | 3.85 | 66.22 | 2.00 | 2.81 | −0.69 | −0.23 | −0.66 | −1.02 |
| 85.10 | 5.40 | 68.24 | 3.22 | 3.68 | −1.08 | −0.46 | −1.07 | −1.32 |
| 105.06 | 6.84 | 56.76 | 2.67 | 1.73 | −1.18 | −0.98 | −1.16 | −1.14 |
| 125.03 | 14.87 | 38.51 | 7.40 | 3.90 | −0.79 | 1.13 | −0.64 | −0.18 |

As can be seen from Table 3, it was confirmed that the composite dielectric composition of Comparative Example 1, composed of the epoxy resin and barium titanate (BaTiO₃), having positive temperature characteristics, exhibits significant dielectric loss as well as very large changes of temperature characteristics, and therefore is not suitable for use in, preparation of a signal-matching embedded capacitor.

The composite dielectric composition of Comparative Example 2 using a TiO₂ filler had a high dielectric constant due to semiconductivity of the ceramic filler per se, but showed significant dielectric loss and great variation of the capacitance. However, incorporation of the SrTiO₃ powder and CaTiO₃ powder in Examples 1 through 6 of the present invention exhibited excellent results of ΔC/C×100(%) ranging from ±7% to ±1.5%, depending upon volume fractions of the added powder. In particular, the samples of Examples 2 through 6 exhibited ΔC/C×100(%) of not more than 5%, representing that they have very suitable properties for use in the formation of a dielectric layer of a signal-matching embedded capacitor. In addition, the samples of Examples 1 through 6 exhibited superior temperature characteristics without a significant decrease of the dielectric constant, i.e., a dielectric constant of 17 to 25, which is similar to a dielectric constant of 23 as shown in Comparative Example 1 using the ferroelectric BaTiO₃ powder.

### Example 7

Composite dielectric compositions were respectively prepared by mixing a ceramic filler and an epoxy resin in a predetermined ratio as set forth in Table 4 below. This Example employed a brominated bisphenol-A epoxy resin as an epoxy resin, a dicyandiamide (DICY) as a curing agent, 2-methylimidazole as a curing accelerator, and 2-methoxyethanol as a solvent, respectively.

110 g of a slurry batch composed of the ceramic filler and epoxy resin mixed in a ratio of vol % as set forth in Table 4 below, curing agent, curing accelerator and dispersing agent was used to prepare a slurry to which a solvent was added in an amount of 10 wt % relative to the batch. Herein, the curing agent and curing accelerator were respectively added in an amount of 52.769 wt % and 0.1 wt %, relative to the epoxy resin. In addition, the dispersing agent was added in an amount of 3 wt %, relative to the ceramic powder. As the ceramic filler, a filler having a particle diameter of about 0.1 to 1 μm was used. The thus-prepared slurry was cast in a thickness of 100 μm over copper foil, by means of hand casting. Thereafter, the dielectric-cast coil foil was semi-cured in a drying oven at 170° C. for 2.5 min, and then compressed at 300 psi for 10 min using WIP.

The thus-compressed samples were laminated at 200° C. for 2 hours to prepare a copper-clad laminate (CCL) which was then etched with the exception of an electrode part, using an aqueous nitric acid solution, thereby preparing samples for measuring temperature characteristics. Using Single Chamber Capacitor Temp Test System (W-2500), variations of capacitance with temperature (Temperature characteristics) for the thus-prepared samples were measured in terms of ΔC/C×100(%) (C: Capacitance at 25° C., and ΔC/C×100: Variation of capacitance with temperature). Temperature characteristics thus measured are given in Table 4.

TABLE 4

| | | | | Resin | | | |
|---|---|---|---|---|---|---|---|
| | | Resin 55 | Resin 50 | 45 | Resin 60 | Resin 50 | Resin 45 |
| | Resin | vol % + | vol % + | vol % + | vol % + | vol % + | vol % + |
| Temp. | 100 | SrTiO₃ | SrTiO₃ 50 | SrTiO₃ | CaTiO₃ 40 | CaTiO₃ 50 | CaTiO₃ 55 |
| (° C.) | vol % | 45 vol % | vol % | 55 vol % | vol % | vol % | vol % |
| −55.00 | −9.34 | −5.706 | −2.138 | 4.996 | −5.338 | −1.003 | 1.163 |
| −24.95 | −5.65 | −3.395 | −1.185 | 3.236 | −3.184 | −0.517 | 0.829 |
| −9.99 | −2.95 | −1.667 | −0.199 | 2.739 | −1.595 | 0.113 | 0.996 |
| 0.03 | −1.97 | −0.897 | 0.120 | 2.152 | −0.884 | 0.277 | 0.854 |
| 10.04 | −0.74 | −0.355 | 0.234 | 1.413 | −0.366 | 0.288 | 0.657 |
| 45.06 | 1.72 | 0.622 | −0.180 | −1.785 | −0.020 | −0.243 | −0.737 |
| 65.03 | 2.95 | 0.788 | −0.766 | −3.874 | −0.206 | −0.873 | −1.722 |
| 85.10 | 3.93 | 0.955 | −1.352 | −5.964 | 1.049 | −1.468 | −2.719 |
| 105.06 | 5.16 | 0.892 | −2.141 | −8.206 | 1.057 | −2.27 | −3.832 |
| 125.03 | 11.55 | 4.492 | 0.326 | −8.005 | 4.361 | −0.504 | −2.921 |

A brominated bisphenol-A epoxy resin exhibits a significant change in temperature characteristics, as compared to common epoxy resins. Therefore, upon using the brominated bisphenol-A epoxy resin, CaTiO₃ and SrTiO₃, both of which are ceramic fillers having negative temperature characteristics, should be used in amounts of about 45±5 vol % and 50 vol %, respectively, in order to satisfy desired temperature characteristics, ΔC/C×100(%) of not more than 5%, so that these ceramic fillers may be used in preparation of a signal-matching embedded capacitor.

In the case of the signal-matching embedded capacitor, temperature characteristics are more important than the dielectric constant. Hence, the ceramic filler in the composite dielectric composition of the present invention is used to improve temperature characteristics rather than the dielectric constant, or is used to compensate for a dielectric loss value. Therefore, the more preferred combination is achieved when the content of the ceramic filler in the composite dielectric composition is low while the variation of capacitance with temperature is also low. Consequently, it is preferred to use the epoxy resin exhibiting small changes in temperature characteristics than the brominated bisphenol-A epoxy resin.

As discussed hereinbefore, conventional composite dielectric compositions, due to a significant variation of capacitance with temperature, were not applicable to signal-matching embedded capacitors and used only in the preparation of decoupling capacitors. However, the composite dielectric composition of the present invention exhibits a little variation of capacitance with temperature and can thus be used as the dielectric layer of the signal-matching embedded capacitor. That is, the composite dielectric composition of the present invention meets desired temperature characteristics in terms of ΔC/C×100(%) of not more than 5%, required for use as the signal-matching embedded capacitor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-14. (canceled)

15. A composite dielectric composition for a signal-matching embedded capacitor comprising: a mixture of a polymer matrix selected from the group consisting of a polyethylene terephthalate resin, a polyimide resin and any combination thereof and exhibiting a positive variation of capacitance with temperature; and
a ceramic filler having MO6 group(s) or a Perovskite structure and exhibiting a negative variation of capacitance with temperature which is reciprocal to that of the polymer matrix,
wherein the mixture of polymer matrix and ceramic filler has variation of capacitance with temperature, ΔC/C×100(%) (C: Capacitance at 25° C., and ΔC: different of capacitance at a temperature range from −55 to 125° C. and at 25° C.), of not more than 5%.

16. The composition according to claim 15, wherein the ceramic filler is selected from the group consisting of calcium titanate, strontium titanate, zinc titanate, bismuth titanate and any combination thereof.

17. The composition according to claim 15, wherein the content of the ceramic filler is less than 60 vol %.

18. The composition according to claim 15, wherein the content of the ceramic filler is less than 50 vol %.

19. The composition according to any one of claims 15 to 18, wherein the ceramic filler has a particle diameter of 10 nm to 10 μm.

20. A signal-matching embedded capacitor including a dielectric layer formed of the composite dielectric composition of claims 15 to 18.

21. A composite dielectric composition for a signal-matching embedded capacitor comprising: a mixture of a polymer matrix selected from the group consisting of a Teflon resin and/or a bismaleimide-methylenedianiline polyimide resin and exhibiting a negative variation of capacitance with temperature; and
a ceramic filler selected from the group consisting of barium titanate, lanthanum titanate, magnesium titanate and any combination thereof and exhibiting a positive variation of capacitance with temperature which is reciprocal to that of the polymer matrix,
wherein the mixture of polymer matrix and ceramic filler has variation of capacitance with temperature, ΔC/C×100(%) (C: Capacitance at 25° C., and ΔC: different of capacitance at a temperature range from −55 to 125° C. and at 25° C.), of not more than 5%.

22. The composition according to claim 21, wherein the polymer matrix is a Teflon resin and the ceramic filler is barium titanate.

23. The composition according to claim 21, wherein the polymer matrix is a bismaleimide-methylenedianiline polyimide resin, and the ceramic filler is lanthanum titanate or magnesium titanate.

24. The composition according to claim 21, wherein the content of the ceramic filler is less than 60 vol %.

25. The composition according to claim 21, wherein the content of the ceramic filler is less than 50 vol %.

26. The composition according to any one of claims 21 to 25, wherein the ceramic filler has a particle diameter of 10 nm to 10 μm.

27. A signal-matching embedded capacitor including a dielectric layer formed of the composite dielectric composition of claims 21 to 25.
